(19) United States
(12) Patent Application Publication
(10) Pub. No.: US 2025/0378816 A1
(43) Pub. Date: Dec. 11, 2025

(54) METHODS AND SYSTEMS FOR TRAINING AN ARTIFICIAL INTELLIGENCE (AI) TOTAL DURATION-AWARE MODEL TO CONTROL THE TOTAL DURATION OF SPEECH UTTERANCES BY A TEXT-TO-SPEECH (TTS) COMPUTING SYTEM

(71) Applicant: MICROSOFT TECHNOLOGY LICENSING, LLC, Redmond, WA (US)

(72) Inventors: Sefik Emre ESKIMEZ, Alrington, VA (US); Xiaofei WANG, Seattle, WA (US); Manthan THAKKER, Redmond, WA (US); Naoyuki KANDA, Bellevue, WA (US); Hemin YANG, Redmond, WA (US); Zirun ZHU, Redmond, WA (US); Min TANG, Bellevue, WA (US)

(21) Appl. No.: 18/789,219

(22) Filed: Jul. 30, 2024

Related U.S. Application Data
(60) Provisional application No. 63/656,238, filed on Jun. 5, 2024.

(51) Int. Cl. G10L 13/08; G10L 25/27

(52) U.S. Cl. CPC G10L 13/08; G10L 25/27

(57) ABSTRACT

Systems and methods are provided for training and using a total duration-aware (TDA) model to control the duration of speech utterances by a text-to-speech computing system when converting text into speech. During use, text to be converted into speech and target output speech time duration are used as inputs into the TDA model. The text is then tokenized into phonemes, and the TDA model predicts frame durations for each phoneme. The TDA model is trained on phonemes derived from text, corresponding actual frame durations for the phonemes, and a target output speech time duration. The TDA model masks a subset of the actual frame durations, and generates predicted frame durations for the subset. A loss between the actual and predicted frame durations is calculated, and used to adjust parameters of the TDA model to control future generation of predicted frame durations.

### CROSS-REFERENCE TO RELATED APPLICATION

This application claims the benefit and priority of U.S. Provisional Patent Application Ser. No. 63/656,238, filed on Jun. 5, 2024, entitled “METHODS AND SYSTEMS FOR TRAINING AN ARTIFICIAL INTELLIGENCE (AI) TOTAL DURATION-AWARE MODEL TO CONTROL THE TOTAL DURATION OF SPEECH UTTERANCES BY A TEXT-TO-SPEECH (TTS) COMPUTING SYSTEM”, and which application is expressly incorporated herein by reference in its entirety.

### BACKGROUND

Text-to-speech (herein referred to as “TTS”) systems are used to generate audible output speech based on an input string of text. TTS systems are often used in “read-aloud” functions in word processors, speech-to-speech real-time language translation, automated dialog replacement (also known as “video dubbing”), as aids for individuals with visual impairments, etc.

In recent years, the efficacy of TTS systems has been aided by the use of Artificial Intelligence (herein referred to as “AI”) models, which are trained on a wide range of input text and corresponding recorded output speech. Accordingly, many conventional AI TTS systems are capable of generating human-sounding output speech (e.g., having nuanced intonation, rhythm, pronunciation, emotion, etc.), particularly when generating output speech at regular speaking rates (e.g., 1× speaking rate).

However, conventional AI TTS systems struggle to maintain intelligibility of generated output speech when generating output speech at higher speaking rates (e.g., 2× speaking rates) and lower speaking rates (e.g., 0.5× speaking rates) compared to regular speaking rates.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Disclosed embodiments include systems and methods for training and using an AI duration model to control the duration of speech utterances by a text-to-speech computing system when converting text into speech.

In some aspects, the techniques described herein relate to a method for training an AI duration model to control the duration of speech utterances by a text-to-speech computing system when converting text into speech, the method including: providing training data to the AI duration model, the training data including a plurality of phonemes derived from a string of text, corresponding actual frame durations for each of the phonemes, and a target output speech time duration; the AI duration model masking actual frame durations for a subset of the plurality of phonemes; the AI duration model generating predicted frame durations for the masked actual frame durations of the subset of the plurality of phonemes; and calculating a loss with a loss function to quantify a difference of at least the predicted frame durations and the actual frame durations, and using the loss to train the AI duration model by adjusting parameters of the AI duration model that are used to generate the predicted frame durations.

In some aspects, the techniques described herein relate to a method for using an AI duration model to control the generation of speech utterances by a text-to-speech computing system when converting text into speech, the method including: obtaining an AI duration model trained to generate phonemes and frame durations for the phonemes based on inputs including text to be converted into speech and a target output speech time duration; identifying the text to be converted into speech; identifying the target output speech time duration; providing the text and the target output speech time duration to the AI duration model, wherein the AI duration model tokenizes the text into a plurality of phonemes and predicts a frame duration for each phoneme in the plurality of phonemes based on the target output speech time duration, such that the summation of the frame durations for the plurality of phonemes is approximately equal to the target output speech time duration; and generating output based on the phonemes and predicted frame duration for each phoneme.

This Summary is provided to introduce a selection of concepts that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be limiting in scope, embodiments will be described and explained with additional specificity and detail through the use of the accompanying drawings in which:

FIG. 1 illustrates a text-to-speech environment, which is an example of a system used for training an AI duration model to control the duration of speech utterances by a text-to-speech computing system when converting text into speech;

FIG. 2 illustrates a flowchart of acts associated with a method that can be implemented by a computing system and is configured for training an AI duration model to control the duration of speech utterances by a text-to-speech computing system when converting text into speech;

FIG. 3 illustrates a flowchart of acts associated with a method that can be implemented by a computing system and is configured for using an AI duration model to control the duration of speech utterances by a text-to-speech computing system when converting text into speech;

FIG. 4 illustrates an example system in which a model is used to generate output speech based on an input original speech, but in which the model is not aware of the target output speech time duration for the output speech;

FIG. 5 illustrates training for a baseline model, a total-duration aware model using regression and/or flow matching techniques, and a total-duration aware masked generative image transformer-based model;

FIG. 6 illustrates a plurality of charts showing word error rate and speaker similarity results for a variety of models; and

FIG. 7 illustrates a computing environment, which is an example of a system for training an AI duration model to control the duration of speech utterances by a text-to-speech computing system when converting text into speech.

### DETAILED DESCRIPTION

Disclosed embodiments include methods and systems for training and using an AI duration model to control the duration of speech utterances by a text-to-speech (herein referred to as “TTS”) computing system when converting text into speech.

Many conventional TTS systems are capable of converting input text into quality output speech at regular speaking rates (e.g., 1× speaking rate). However, such TTS models struggle to maintain intelligibility of generated output speech when generating output speech at higher speaking rates (e.g., 2× speaking rates) and lower speaking rates (e.g., 0.5× speaking rates) compared to regular speaking rates.

For example, in the case of a TTS system being used for video dubbing, speech of a first language is used to generate speech of a second language. More specifically, speech of the first language is used to generate corresponding text of the first language (e.g., via an automatic speech recognition model). The text of the first language is then translated into text of the second language (e.g., via a text language translation model). The text of the second language is then used to generate corresponding output speech of the second language (e.g., via a TTS model).

When generating speech from text, it is advantageous to be able to precisely control the time duration of the output speech. For example, in the case of video dubbing, the intention is to match the time duration of the output speech of the second language with the time duration of the original speech of the first language. However, when matching the time duration of the output speech to the time duration of the original speech, due to factors such as differences in phoneme durations, word pronunciations, and sentence structure between different languages, the generated output speech may have a speaking rate is different from the speaking rate of the original speech. Particularly, when matching the time duration of the output speech to the time duration of the original speech using common techniques such as linear time-scale modification, this can result in the output speech being unintelligible.

To help address this issue, a total duration-aware (herein referred to as “TDA”) model is provided and trained to predict frame durations for the phonemes corresponding to an input text, such that the output speech has high clarity, intelligibility, and speaker similarity, regardless of the speaking rate of the output speech. This is particularly achieved by using a target output speech time duration as an additional input into the TDA model, hence the term “total duration-aware” model.

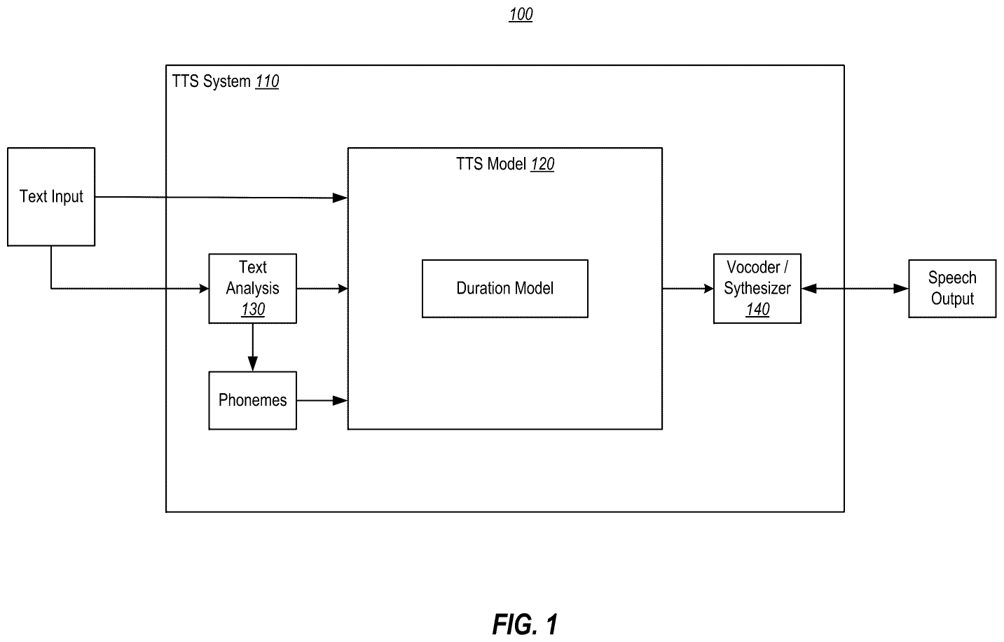

Attention will now be directed to FIG. 1, which illustrates a TTS environment 100, which is an example of a system used for training and using a TDA model to control the duration of speech utterances (i.e., to control the frame durations for each phoneme that is to make up a speech utterance) by a TTS computing system when converting text into speech. The TTS environment 100 includes a TTS System 110, which receives a string of text as an input, and generates speech output based on the string of text. The TTS System 110 includes a TTS model 120. In the embodiment illustrated in FIG. 1, the TTS model 120 includes a duration model. In another embodiment, the TTS model 120 instead communicates and/or interfaces with a duration model.

As illustrated in FIG. 1, the text input is received directly into the TTS model 120. Further, the text input is received by a text analysis component 130. The text analysis component 130 performs preprocessing (e.g., text normalization, tokenization, prosody assignment, etc.) on the input text, and maps the input text to corresponding phonemes. In some embodiments, the text analysis component 130 accesses a phoneme index when mapping the input text to corresponding phonemes. In other embodiments, the input text is mapped to corresponding phonemes using an AI phoneme model.

During training of the TDA model, the TTS model 120 receives each of the input text, the corresponding mapped phonemes, actual frame durations for each of the phonemes, and the target output speech time duration as inputs. For clarity, the term “frame durations” refers to the number of frames that a phoneme will be pronounced when uttered in the form of output speech. During run-time of the TDA model, the TTS model 120 generates an audio representation of text input (e.g., in the form of one or more Mel-Spectrograms), and a vocoder/synthesizer 140 uses the audio representation to generate an output waveform (e.g., a time-domain signal) corresponding to speech output.

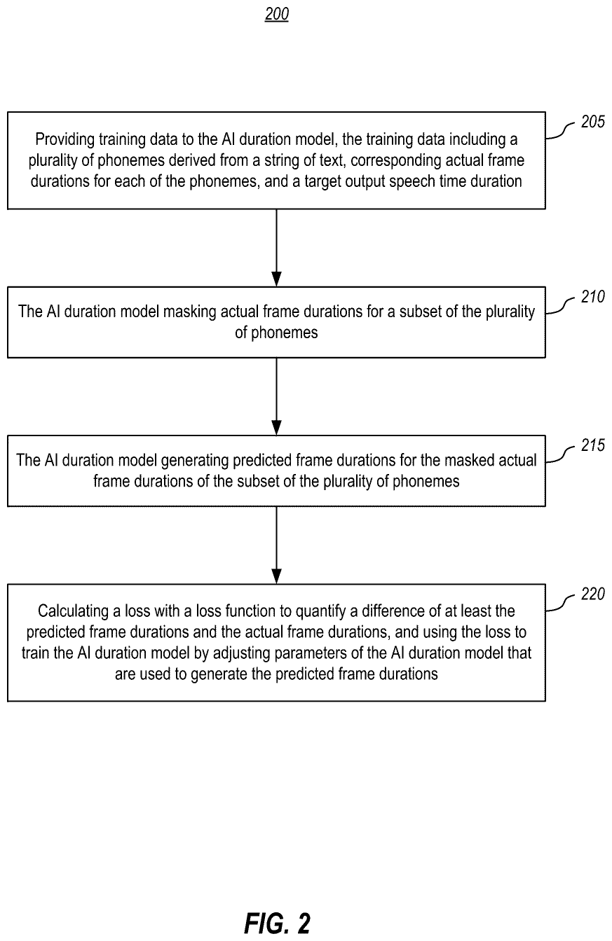

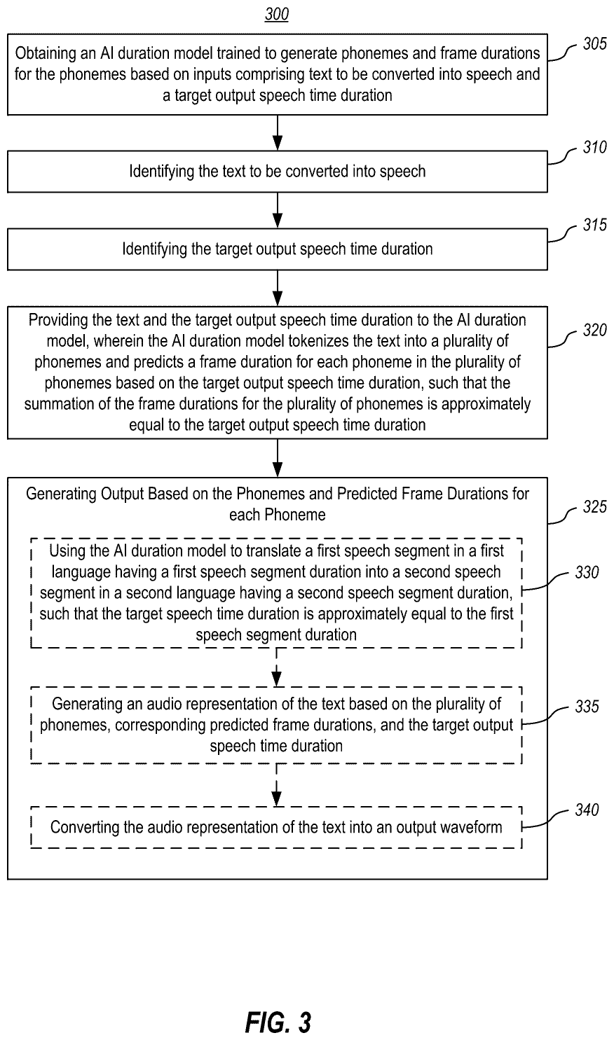

Attention will now be directed to FIG. 2, which illustrates a flowchart of acts (act 205, act 210, act 215 and act 220) corresponding to a method 200 for training a TDA model to control the duration of speech utterances by a TTS computing system when converting text into speech. Subsequently, a method for using the TDA model after it has been trained as described with respect to FIG. 2 will be described with respect to FIG. 3.

A first illustrated act is provided for providing training data to the TDA model (act 205). As previously expressed with respect to FIG. 1, the training data includes input text, phonemes corresponding to the input text, corresponding actual frame durations for each of the phonemes, and a target output speech time duration. Training data for conventional TTS duration models does not include target output speech time duration. The inventors have found that using the target output speech time duration as an additional input along with the training data can produce models that are better trained for generating intelligible TTS outputs at a variety of speaking rates.

During training, the TDA model masks the actual frame durations for a subset of the phonemes (act 210). In one embodiment, this masking is performed using a regression and/or flow-matching technique in which the actual frame durations for the subset of phonemes are masked sequentially. However, in another embodiment, the masking is performed using a MaskGIT-style (i.e., “masked generative image transformation”-style) decoding technique, in which the actual frame durations for the subset of the phonemes are masked non-sequentially and randomly. The use of the MaskGIT-style decoding technique results in high sample diversity and quality as compared to other techniques. For context, the term “sample diversity” refers to the range and variety of speech samples, which allows for greater flexibility in generating output speech for different pitch, intonation, accent/dialect, speaking style, speaking rate, and other acoustic characteristics. Accordingly, a high sample diversity allows for greater intelligibility in output speech at a variety of speaking rates.

The TDA model then generates predicted frame durations for the masked actual frame durations of the subset of the phonemes (act 215), such that the predicted frame durations for the masked actual frame durations of the subset of the phonemes, as well as the actual frame durations for the remaining unmasked actual frame durations, add up to the target output speech time duration.

In the embodiment in which the actual frame durations are masked using the MaskGIT-style decoding technique, the predicted frame durations for the masked frame durations of the subset of phonemes are predicted iteratively, thereby increasing accuracy of the predicted frame durations.

As an example, suppose that there are ten masked frame durations. In this example, in a first iteration, the TDA MaskGIT model generates the predicted frame duration for only one of the masked frame durations. In the next iteration, the TDA MaskGIT model then uses the predicted frame duration for the one previously predicted masked frame duration to more accurately generate three additional predicted frame durations for masked frame durations. Then, in the next iteration, the TDA MaskGIT model uses the four already-generated predicted frame durations to more accurately generate the predicted frame durations for the remaining six masked frame durations.

The principles described herein are not limited to the number of iterations of generating predicted frame durations for the masked frame durations, and are not limited to the number of masked frame durations compared to non-masked actual frame durations.

Returning to FIG. 2, the TDA model then calculates a loss with a loss function (e.g., mean-squared error loss, cross-entropy loss, L2 loss, etc.) to quantify a difference of at least the predicted frame durations and their corresponding actual frame durations (act 220). The loss is then used to modify the parameters/weights of the TDA model to control the future generation of predicted frame durations.

Attention will now be directed to FIG. 3, which illustrates a flowchart of acts (act 305, act 310, act 315, act 320, act 325, act 330, act 335 and act 340) corresponding to a method 300 for using a TDA model (e.g., the TDA model trained as described with respect to FIG. 2) to control the duration of speech utterances by a TTS computing system when converting text into speech (e.g., during run-time).

A first illustrated act is provided for obtaining a TDA model trained to generate phonemes and frame durations for the phonemes based on inputs comprising text to be converted into speech and a target output speech time duration (act 305).

Next, text is identified to be converted into speech (act 310). In some embodiments, the text to be converted into speech is a string of text, or other textual data. In one embodiment, in the case of video dubbing, the text to be converted into speech is text of a second language that has been translated from text of a first language, the text of the first language having been generated using speech of the first language (e.g., via an automatic speech recognition model).

Next, a target output speech time duration is identified (act 315). As previously described, in some embodiments, as in the case of video dubbing, the target output speech time duration is approximately equal to the time duration of an original speech. For example, the target output speech time duration is the desired time duration for the output speech in the second language, where the target output speech time duration is approximately equal to the time duration of the original speech in the first language.

Note that, while act 315 is illustrated in FIG. 3 as taking place after act 310, in some embodiments, both the text to be converted into speech as well as the target output speech time duration are identified simultaneously. In some embodiments, the target output speech time duration is identified before the identification of the text to be converted into speech.

Next, the text to be converted into speech and the target output speech time duration are provided to the TDA model (act 320). The TDA model tokenizes the text into a plurality of phonemes and predicts a frame duration for each phoneme in the plurality of phonemes based on the target output speech time duration, such that the summation of the frame durations for the plurality of phonemes is approximately equal to the target output speech time duration.

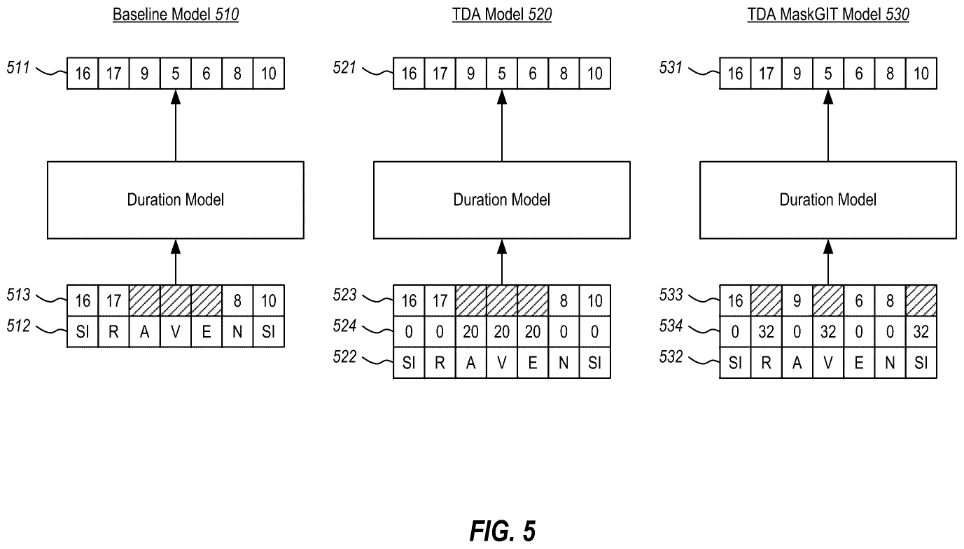

To give an example, suppose that the input text was comprised of the word “cat”. In this example, the input text of the word “cat” has three phonemes (i.e., units of sound): /k/ /a/ /t/; which represents the sounds (i.e., phones) used to pronounce the word “cat”. In some embodiments, input text is divided into sub-units (e.g., words) that each contain phonemes, and frames of silence are included between those sub-units, as will be described later with respect to FIG. 5.

In some embodiments, the TDA model predicts the frame durations for the phonemes iteratively, in parallel, and/or randomly, as may be the case if the TDA model uses the MaskGIT-style decoding technique. In other embodiments, the TDA model predicts the frame durations for the phonemes sequentially, as may be the case if the TDA model uses the regression and/or flow-matching based decoding techniques. Due to the manner in which the TDA model was trained, the predicted frame time durations will lead to output speech that has high clarity, intelligibility, and speaker similarity, even at high speaking rates.

Next, the TDA model generates output based on the phonemes and predicted frame durations for each phoneme (act 325). This output may be further processed in several ways. For example, as illustrated in FIG. 3, act 325 may include several optional steps.

For example, as is the case in the scenario of video dubbing, the TDA model may be used to translate a first speech segment in a first language having a first speech segment duration into a second speech segment in a second language having a second speech segment duration, such that the target speech time duration is approximately equal to the first speech segment duration (act 330).

Further, the TDA model (or alternatively, a TTS model containing or accessing the TDA model, such as the TTS model 120 of FIG. 1) then generates an audio representation (e.g., one or more Mel-spectrograms) of the text based on the plurality of phonemes, corresponding predicted frame durations, and the target output speech time duration (act 330). A vocoder/synthesizer (e.g., the vocoder/synthesizer 140 of FIG. 1) then converts the audio representation of the text into an output waveform (e.g., a time-domain signal) corresponding to output speech (act 335). Subsequently, the output waveform may be played via an audio output device (e.g., speaker, headphones, etc.).

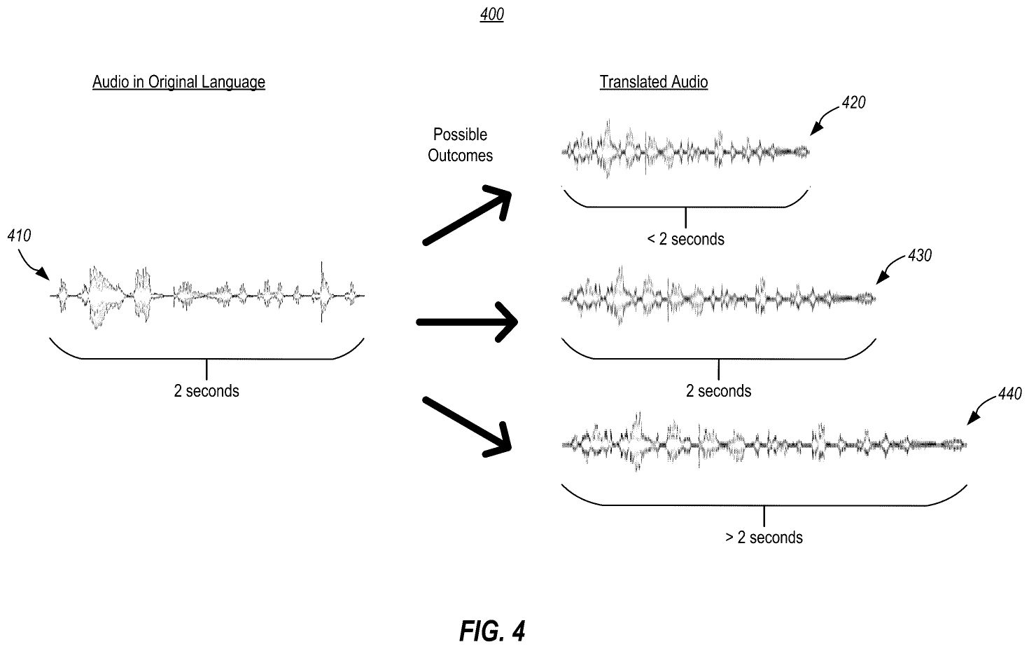

Returning now to the concept of video dubbing, FIG. 4 illustrates an example conventional system 400 in which a conventional model is used to generate output speech (e.g., output speech 420, 430 or 440) based on an input original speech (e.g., input speech 410), but in which the conventional model is not aware of the target output speech time duration for the output speech.

As previously expressed, when generating speech from text, it is advantageous to be able to precisely control the time duration of the output speech. In the case of video dubbing, the intention is to match the time duration of the output speech of the second language with the time duration of the original speech of the first language. However, due to factors such as differences in phoneme durations, word pronunciations, and sentence structure between different languages, the generated output speech may have a different speaking rate and/or a different total time duration than the original speech.

In the example conventional system 400 illustrated in FIG. 4, the input speech 410 has a total duration of 2 seconds. However, due to at least the language differences expressed above, the generated output speech may have a different total duration than the input speech 410. For example, one possibility is for the output speech to have a total duration that is less than the total duration of the input speech 410, as is the case with the output speech 420. Another possibility is for the output speech to have a total duration that is more than the total duration of the input speech 410, as is the case with the output speech 440. In some rare cases, another possibility is for the output speech to approximately match the total duration of the input speech 410, as is the case with output speech 430. However, this is not likely to occur, and so it is not advantageous to rely on models which do not have precise control over the duration of their output speech.

One solution to this problem is to linearly expand or compress the output speech to fit the target output speech time duration. However, this technique often produces output speech that has severe unintelligibility and low speaker similarity, especially at high speaking rates. Another solution is to add or remove silence frames between words in the output speech so as to fit the output speech to the target output speech time duration. However, this solution often leads to low quality output speech that is awkward, and lacks smoothness and elegance. The inventors have discovered that a preferred method for generating output speech that has high intelligibility, high clarity and quality, low word error rate, high speaker similarity, and large sample diversity, in a wide variety of speaking rates, is to use a model (i.e., the TDA model) that has been trained to predict and manipulate frame durations for each individual phoneme using both the input text (e.g., for context) and the target output speech time duration as inputs.

Attention will now be directed to FIG. 5, which illustrates training for a baseline duration model 510, a TDA model 520 using regression and/or flow-matching techniques, and a TDA MaskGIT-based model 530.

The baseline model 510 estimates a duration sequence 511 (i.e., the frame duration of each phoneme for the output speech, or the number of frames that each phoneme will last during the output speech) based on a phoneme sequence 512 and a duration context 513 as inputs. Note that the baseline duration model 510 does not use the target output speech time duration as an input.

During training, the phoneme sequence 512 and the duration context 513 are used as inputs. The duration context 513 includes known frame durations for some of the phonemes of the phoneme sequence 512. However, the duration context 513 also includes masked frame durations for some of the phonemes. Accordingly, to train the baseline duration model 510, the baseline duration model 510 predicts the masked frame durations based on the known frame durations, and outputs the predicted duration sequence 511. This predicted duration sequence 511 is then compared against a ground truth duration sequence, and a loss is calculated between the predicted duration sequence 511 and the ground truth duration sequence. This loss is then used to adjust parameters/weights of the baseline duration model 510 so that the baseline duration model 510 gets better at estimating the duration sequence 511.

As previously described, the baseline duration model 510 does not include the target output speech time duration as an input. Instead, during training, after predicting the masked frame durations, the predicted masked frame durations may then be linearly scaled so that the predicted duration sequence 511 is equal to the target output speech time duration. However, as previously expressed, linearly scaling frame durations results in unintelligibility and low speaker similarity, especially at high speaking rates. Accordingly, it is advantageous to train duration models (e.g., TDA model 520 and TDA MaskGIT model 530) using the target output speech time duration as an additional input, and not simply adjusting the already-generated output to fit the target output speech time duration.

To give an example, the TDA model 520 estimates a duration sequence 521 based on a phoneme sequence 522, a duration context 523, and a target total duration 524 as inputs. The duration context 523 includes sequential masked frame durations (since the TDA model 520 uses a regression and/or flow-matching technique) for some of the phonemes of the phoneme sequence 522, and known frame durations for the remaining phonemes. In the example illustrated in FIG. 5, the target output speech time duration corresponds to the phonemes (including silence frames) having 71 total frames. The known frame durations are subtracted from the total frames, so that the duration model knows how many remaining frames are allocated for the masked frame durations.

For example, in FIG. 5, 51 of the 71 frames are allocated to known frame durations, which leaves 20 frames to be allocated between the three sequential masked frame durations. The TDA model 520 predicts the masked frame durations based at least on the known frame durations and the knowledge of how many remaining frames are allocated for the masked frame durations, and outputs the predicted frame duration sequence 521. The predicted duration sequence 521 is compared against the ground truth duration sequence, and a loss is calculated between the predicted duration sequence and the ground truth duration sequence. The loss is then used to adjust the parameters/weights of the TDA model 520 so that the TDA model 520 gets better at predicting the duration sequence 521.

However, training a duration model by using a duration context that has sequentially masked frame durations leads to a lack of sample diversity. As previously expressed, the inventors have found that using a MaskGIT-style decoding technique results in high sample diversity and quality as compared to other techniques.

Accordingly, the TDA MaskGIT model 530 estimates a duration sequence 531 based on a phoneme sequence 532, a duration context 533, and a target total duration 534 as inputs. The duration context 533 includes randomly masked frame durations (since the TDA MaskGIT model 530 uses a MaskGIT-style decoding technique) for some of the phonemes in the phoneme sequence 532, and known frame durations for the remaining phonemes. In the example illustrated in FIG. 5, the target output speech time duration corresponds to the phonemes (including silence frames) having 71 total frames. The known frame durations are subtracted from the total frames, so that the duration model knows how many remaining frames are allocated for the masked frame durations.

For example, in FIG. 5, 39 of the 71 frames are allocated to known frame durations, which leaves 32 frames to be allocated between the three randomly masked frame durations. The TDA MaskGIT model 530 iteratively predicts the masked frame durations based at least on the known frame durations and the knowledge of how many remaining frames are allocated for the masked frame durations. For example, in the first iteration, the TDA MaskGIT model 530 generates the predicted frame duration for only one of the masked frame durations of the duration context 533. In the next iteration, since there are only two remaining masked frame durations in the example illustrated in FIG. 5, the TDA MaskGIT model 530 then uses the predicted frame duration for the previously predicted masked frame duration to more accurately generate the predicted frame durations for the remaining masked frame durations. In other embodiments, there may be many more masked frame durations, in which case a TDA MaskGIT model may perform more iterations for predicting the masked frame durations. In another embodiment, only a few frame durations are masked and need to be predicted, in which case perhaps only one iteration for predicting the masked frame durations is performed.

In any case, the TDA MaskGIT model 530 outputs the predicted frame duration sequence 531. The predicted duration sequence 531 is compared against the ground truth duration sequence, and a loss is calculated between the predicted duration sequence and the ground truth duration sequence. The loss is then used to adjust the parameters/weights of the TDA MaskGIT model 530 so that the TDA MaskGIT model 530 gets better at predicting the duration sequence 531.

In some embodiments, the TDA MaskGIT model utilizes algorithms for converting text into speech, such as the following algorithm:

```
for t ← 1 to T do
  D_{_{probs}} ← G^{TDA} (P, D^{ctx}, D^{tgt}; θ) > Predict probabilities
  \hat{D}, c ← Sample (D_{probs}) > Sample duration values
  andtheir confidence scores [symbol]
  ← UniformNormalize(\hat{D}) > Normalize the sample
  durations to sum up to target duration
  $k ← [ γ ( \frac{1}{T} ) N ]$
  > Get the number of tokens to fill for this iteration
  M^{(t+1)} ← UnmaskTopN(c,k) > Select the top n most
  confident frames
  M_{diff} ← abs(M^{(t+1)} − M^{(t)}) > Identify filled tokens
  D^{ctx}[M_{diff}] [symbol] [M_{diff}] > Update context
  d^{tgt} ← d^{tgt} − sum ( [symbol]  [M_{diff}]) > Update target duration
  ${D}^{tgt} ← [ {m}_{1}^{( t + 1 )} {d}^{tgt} , {m}_{2}^{( t + 1 )} {d}^{tgt} , … , {m}_{N}^{( t + 1 )} {d}^{tgt} ]$
end for
```

According to the foregoing algorithm, G^{TDA} is the duration model, P is the input phoneme sequence, D^{ctx} is the input masked duration sequence, where only masked values will be predicted, D^{tgt} is the target duration sequence, c is the confidence value, γ is the scheduling function, and M^{t} is the mask sequence at step t (1 for known, 0 for unknown values).

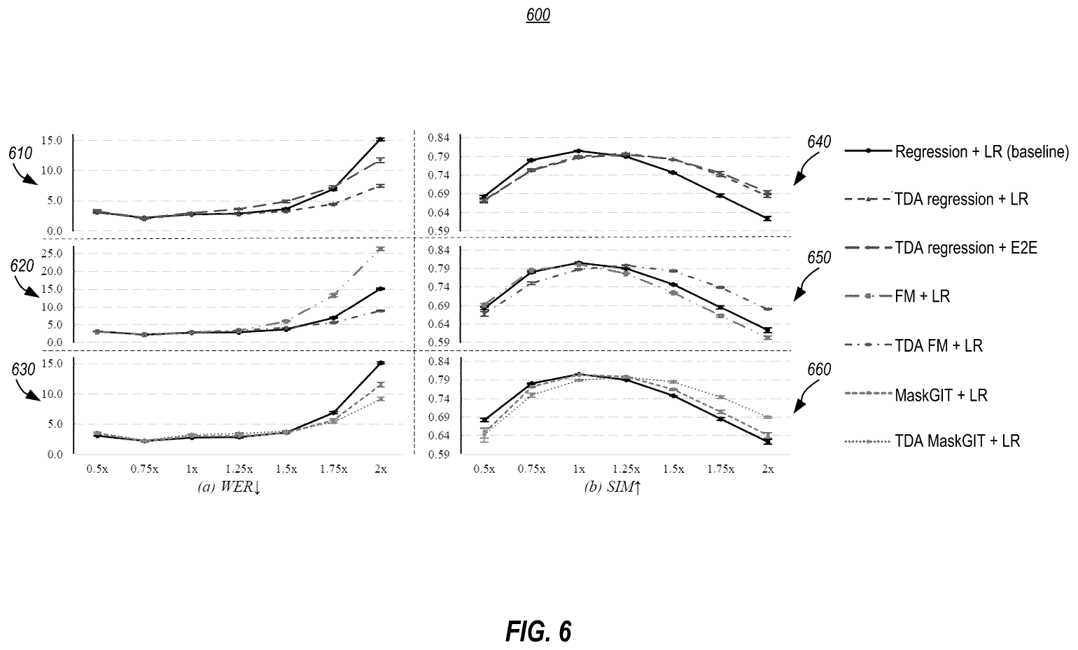

While the TDA MaskGIT model is shown to produce output speech with high intelligibility, high clarity and quality, low word error rate, high speaker similarity, and large sample diversity, in a wide variety of speaking rates, there are other durations models that may also be effective at producing output speech. Thus, attention will now be directed to FIG. 6, which illustrates a plurality of charts showing the word error rate (WER) and speaker similarity (SIM) for seven different duration models.

A first column of charts includes three charts 610, 620 and 630 comparing the WER for each model, where lower WER corresponds to the model having better performance in WER. A second column of charts includes three charts 640, 650 and 660 comparing the SIM for each model, where higher SIM corresponds to the model having better performance in SIM. Each chart illustrates the performance of the models from a speaking rate of 0.5× to 2×, with 0.25× increments. Note that while each of the models perform decently around the 1× speaking rate, many of the models exhibit poor performance in both WER and SIM at higher speaking rates. Accordingly, the performance of each model will now be briefly compared with a focus on performance at the 2× speaking rate.

Chart 610 compares WER for a baseline regression model with a length regulator/normalization (referred to as “Regression+LR (baseline) in FIG. 6), a TDA regression model using normalization (referred to as “TDA regression+LR”), and a TDA regression model that includes end-to-end (E2E) normalization training (referred to as “TDA regression+E2E”).

Chart 620 compares WER for the Regression+LR baseline model, a flow-matching model using normalization (referred to as “FM+LR”), and a total duration-aware flow-matching model using normalization (referred to as “TDA FM+LR”).

Chart 630 compares WER for the Regression+LR baseline model, a MaskGIT model with normalization (referred to as “MaskGIT+LR”), and a TDA MaskGIT model with normalization (referred to as “TDA MaskGIT+LR).

Chart 640 compares SIM for the Regression+LR baseline model, the TDA regression+LR model, and the TDA regression+E2E model. Chart 650 compares SIM for the Regression+LR baseline model, the FM+LR model, and the TDA FM+LR model. Chart 660 compares SIM for the Regression+LR baseline model, the MaskGIT+LR model, and the TDA MaskGIT+LR model.

As illustrated in charts 610 through 660, the models that use the TDA technique have better performance in WER and SIM than their non-TDA counterparts. Charts 610 and 640 show that using a length regulator/normalization is more effective than implementing end-to-end normalization training. Of the non-TDA models, the MaskGIT+LR had the best performance in WER and SIM, indicating that MaskGIT can generate a more accurate distribution compared to the training data. Accordingly, the inventors have found that the most well-rounded model for high intelligibility, high clarity and quality, low WER, high SIM and large sample diversity, in a wide variety of speaking rates, is the TDA MaskGIT+LR model.

Accordingly, the principles described herein allow for the training and use of TDA models that take the target output speech time duration as an extra input, and that are capable of producing output speech with high intelligibility, high clarity and quality, low word error rate, high speaker similarity, and large sample diversity, in a wide variety of speaking rates.

### Example Computing Systems

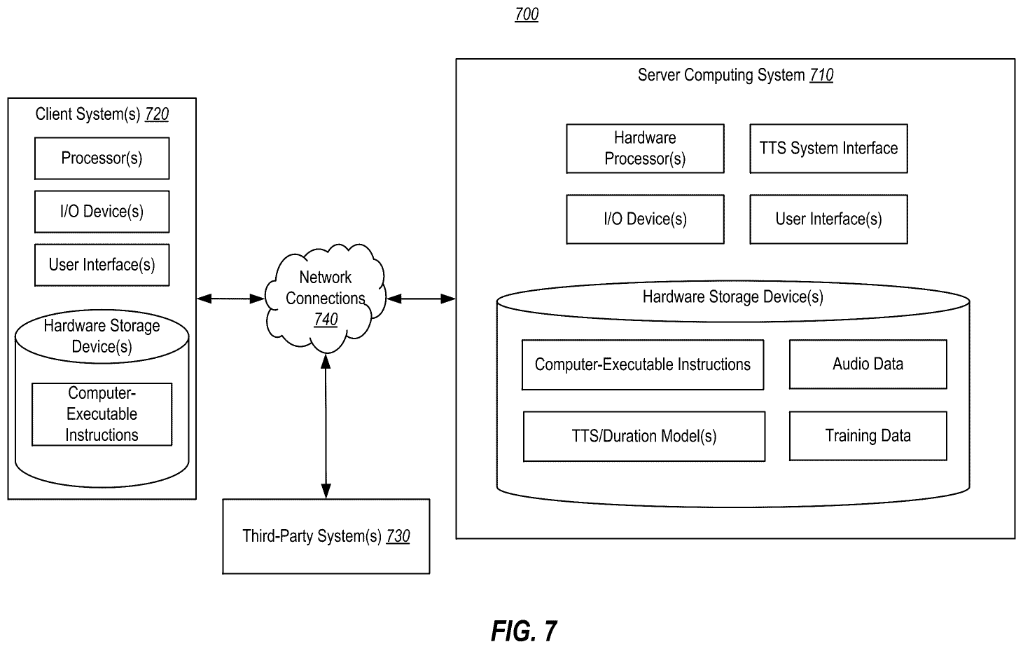

Attention will now be directed to FIG. 7, which illustrates the computing system 710 as part of a computing environment 700 that includes client system(s) 720 and third-party system(s) 730 in communication (via a network 740) with the computing system 710. As illustrated, computing system 710 is a server computing system configured to access and train a TTS duration model with audio data and training data (e.g., via a TTS System Interface).

Computing system 710 may comprise and/or be used to implement the embodiments claimed herein. For example, the computing system 710 includes one or more processor(s) (such as one or more hardware processor(s) and one or more hardware storage device(s) storing computer-readable instructions that are executable by one or more hardware processors to implement the functionality disclosed herein. The computing system 710 is also shown including user interface(s) and input/output (I/O) device(s) configured to receive inputs and to render outputs.

As shown in FIG. 7, hardware storage device(s) are shown as a single storage unit. However, it will be appreciated that the hardware storage device(s) can also be a distributed storage that is distributed to several separate and sometimes remote systems and/or third-party system(s). The computing system 710 can also comprise a distributed system with one or more of the components of computing system 710 being maintained/run by different discrete systems that are remote from each other and that each system performs different tasks. In some instances, a plurality of distributed systems performs similar and/or shared tasks for implementing the disclosed functionality, such as in a distributed cloud environment.

In some instances, the audio data is natural language audio and/or synthesized audio data. Input audio data is retrieved from previously recorded files such as video recordings having audio or audio-only recordings. Some examples of recordings include videos, podcasts, voicemails, voice memos, songs, etc. Audio data is also retrieved from actively streaming content which is live continuous speech such as a news broadcast, phone call, virtual or in-person meeting, etc. In some instances, a previously recorded audio file is streamed. Natural audio data is recorded from a plurality of sources, including applications, meetings comprising one or more speakers, ambient environments including background noise and human speakers, etc. It should be appreciated that natural language audio comprises one or more spoken languages of the world's spoken languages. Thus, the models described herein are trainable in one or more languages.

The audio data further comprises spoken language utterances (e.g., natural language and/or synthesized speech) and corresponding textual transcriptions (e.g., text data). The training data comprises text data, phonemes derived from the text data, corresponding actual frame durations for each of the phonemes, and target output speech time duration. In other words, the actual frame durations for the phonemes are the ground truth output for the text data input.

The server computing system 710 is in communication with client system(s) 720 comprising one or more processor(s), one or more user interface(s), one or more I/O device(s), one or more sets of computer-executable instructions, and one or more hardware storage device(s).

The server computing system 710 is also in communication with third-party system(s) 730. It is anticipated that, in some instances, the third-party system(s) 730 further comprise databases housing data that could be used as training data, for example, text data not included in local storage. Additionally, or alternatively, the third-party system(s) 730 includes machine learning systems external to the computing system 710.

The server computing system 710 may obtain any of the referenced training data and models from the client system and/or third-party systems. The server computing system may also obtain prompts from the client and third-party systems for fine-tuning the AI duration model, as described herein, such as in a one-shot or multiple shot prompt fine-tuning process.

Embodiments of the present invention may comprise or utilize a special-purpose or general-purpose computer (e.g., computing system 710) including computer hardware, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., hardware storage device(s)) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 740) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### NUMBERED CLAUSES

The present invention can also be described in accordance with the following numbered clauses.

Clause 1. A method for training an AI duration model to control the duration of speech utterances by a text-to-speech computing system when converting text into speech, the method comprising: providing training data to the AI duration model, the training data including a plurality of phonemes derived from a string of text, corresponding actual frame durations for each of the phonemes, and a target output speech time duration; the AI duration model masking actual frame durations for a subset of the plurality of phonemes; the AI duration model generating predicted frame durations for the masked actual frame durations of the subset of the plurality of phonemes; and calculating a loss with a loss function to quantify a difference of at least the predicted frame durations and the actual frame durations, and using the loss to train the AI duration model by adjusting parameters of the AI duration model that are used to generate the predicted frame durations.

Clause 2. The method according to Clause 1, where the target output speech time duration is approximately equal to a time duration for an initial speech.

Clause 3. The method according to Clause 2, where the string of text and the speech generated from the string of text are of a first language, and the initial speech is of a second language, such that the target output speech time duration for the speech of the first language is approximately equal to the time duration for the initial speech of the second language.

Clause 4. The method according to Clause 1, where the target output speech time duration is greater than a time duration for an initial speech, where speech at the target output speech time duration is a speed-up version of the initial speech.

Clause 5. The method according to Clause 1, where the target output speech time duration is less than a time duration for an initial speech, where speech at the target output speech time duration is a slowed-down version of the initial speech.

Clause 6. The method according to Clause 1, the method further comprising parsing the string of text into a plurality of phonemes.

Clause 7. The method according to Clause 1, where the AI model masks the actual frame durations for the subset of the plurality of phonemes non-sequentially.

Clause 8. The method according to Clause 1, where the AI model masks the actual frame durations for the subset of the plurality of phonemes randomly.

Clause 9. The method according to Clause 1, where the loss is calculated using mean-squared error loss.

Clause 10. The method according to Clause 1, where the loss is calculated using cross-entropy loss.

Clause 11. The method according to Clause 1, the method further comprising generating one or more audio representations based on the phonemes, frame time durations for the phonemes, and the target output speech time duration.

Clause 12. The method according to Clause 11, the audio representations being one or more Mel spectrograms.

Clause 13. The method according to Clause 11, the method further comprising converting the audio representations into an output waveform.

Clause 14. The method according to Clause 13, where the output waveform is a time-domain signal.

Clause 15. A method for using an AI duration model to control the generation of speech utterances by a text-to-speech computing system when converting text into speech, the method comprising: obtaining an AI duration model trained to generate phonemes and frame durations for the phonemes based on inputs comprising text to be converted into speech and a target output speech time duration; identifying the text to be converted into speech; identifying the target output speech time duration; providing the text and the target output speech time duration to the AI duration model, wherein the AI duration model tokenizes the text into a plurality of phonemes and predicts a frame duration for each phoneme in the plurality of phonemes based on the target output speech time duration, such that the summation of the frame durations for the plurality of phonemes is approximately equal to the target output speech time duration; and generating output based on the phonemes and predicted frame duration for each phoneme.

Clause 16. The method according to Clause 15, wherein the method includes using the AI duration model to translate a first speech segment in a first language having a first speech segment duration into a second speech segment in a second language having a second speech segment duration, such that the target speech time duration is approximately equal to the first speech segment duration.

Clause 17. The method according to Clause 15, the method further comprising generating an audio representation of the output based on the plurality of phonemes, corresponding predicted frame durations, and the target output speech time duration.

Clause 18. The method according to Clause 17, the method further comprising converting the output into an output waveform.

Clause 19. The method according to Clause 19, where the output waveform is a time-domain signal.

Clause 20. The method of Clause 15, wherein the AI duration model was previously trained with training data including a plurality of phonemes derived from a string of text, corresponding actual frame durations for each of the phonemes, and a target output speech time duration, wherein the training of the AI duration model included: the AI duration model masking actual frame durations for a subset of the plurality of phonemes; the AI duration model generating predicted frame durations for the masked actual frame durations of the subset of the plurality of phonemes; and calculating a loss with a loss function to quantify a difference of at least the predicted frame durations and the actual frame durations, and using the loss to train the AI duration model by adjusting parameters of the AI duration model that are used to generate the predicted frame durations.

What is claimed is:

1. A method for training an AI duration model to control the duration of speech utterances by a text-to-speech computing system when converting text into speech, the method comprising:
providing training data to the AI duration model, the training data including a plurality of phonemes derived from a string of text, corresponding actual frame durations for each of the phonemes, and a target output speech time duration;
the AI duration model masking actual frame durations for a subset of the plurality of phonemes;
the AI duration model generating predicted frame durations for the masked actual frame durations of the subset of the plurality of phonemes; and
calculating a loss with a loss function to quantify a difference of at least the predicted frame durations and the actual frame durations, and using the loss to train the AI duration model by adjusting parameters of the AI duration model that are used to generate the predicted frame durations.

2. The method according to claim 1, where the target output speech time duration is approximately equal to a time duration for an initial speech.

3. The method according to claim 2, where the string of text and the speech generated from the string of text are of a first language, and the initial speech is of a second language, such that the target output speech time duration for the speech of the first language is approximately equal to the time duration for the initial speech of the second language.

4. The method according to claim 1, where the target output speech time duration is greater than a time duration for an initial speech, where speech at the target output speech time duration is a speed-up version of the initial speech.

5. The method according to claim 1, where the target output speech time duration is less than a time duration for an initial speech, where speech at the target output speech time duration is a slowed-down version of the initial speech.

6. The method according to claim 1, the method further comprising parsing the string of text into a plurality of phonemes.

7. The method according to claim 1, where the AI model masks the actual frame durations for the subset of the plurality of phonemes non-sequentially.

8. The method according to claim 1, where the AI model masks the actual frame durations for the subset of the plurality of phonemes randomly.

9. The method according to claim 1, where the loss is calculated using mean-squared error loss.

10. The method according to claim 1, where the loss is calculated using cross-entropy loss.

11. The method according to claim 1, the method further comprising generating one or more audio representations based on the phonemes, frame time durations for the phonemes, and the target output speech time duration.

12. The method according to claim 11, the audio representations being one or more Mel spectrograms.

13. The method according to claim 11, the method further comprising converting the audio representations into an output waveform.

14. The method according to claim 13, where the output waveform is a time-domain signal.

15. A method for using an AI duration model to control the generation of speech utterances by a text-to-speech computing system when converting text into speech, the method comprising:
obtaining an AI duration model trained to generate phonemes and frame durations for the phonemes based on inputs comprising text to be converted into speech and a target output speech time duration;
identifying the text to be converted into speech;
identifying the target output speech time duration;
providing the text and the target output speech time duration to the AI duration model, wherein the AI duration model tokenizes the text into a plurality of phonemes and predicts a frame duration for each phoneme in the plurality of phonemes based on the target output speech time duration, such that the summation of the frame durations for the plurality of phonemes is approximately equal to the target output speech time duration; and
generating output based on the phonemes and predicted frame duration for each phoneme.

16. The method according to claim 15, wherein the method includes using the AI duration model to translate a first speech segment in a first language having a first speech segment duration into a second speech segment in a second language having a second speech segment duration, such that the target speech time duration is approximately equal to the first speech segment duration.

17. The method according to claim 15, the method further comprising generating an audio representation of the output based on the plurality of phonemes, corresponding predicted frame durations, and the target output speech time duration.

18. The method according to claim 17, the method further comprising converting the output into an output waveform.

19. The method according to claim 19, where the output waveform is a time-domain signal.

20. The method of claim 15, wherein the AI duration model was previously trained with training data including a plurality of phonemes derived from a string of text, corresponding actual frame durations for each of the phonemes, and a target output speech time duration, wherein the training of the AI duration model included:
the AI duration model masking actual frame durations for a subset of the plurality of phonemes;
the AI duration model generating predicted frame durations for the masked actual frame durations of the subset of the plurality of phonemes; and
calculating a loss with a loss function to quantify a difference of at least the predicted frame durations and the actual frame durations, and using the loss to train the AI duration model by adjusting parameters of the AI duration model that are used to generate the predicted frame durations.
